(19) United States
(12) Patent Application Publication
(10) Pub. No.: US 2011/0284485 A1
(43) Pub. Date: Nov. 24, 2011

(54) ADJUSTABLE SHELVING DISPLAY

(76) Inventor: Robert P. Sparkowski, Schaumburg, IL (US)

(21) Appl. No.: 13/112,838

(22) Filed: May 20, 2011

Related U.S. Application Data
(60) Provisional application No. 61/347,167, filed on May 21, 2010.

(51) Int. Cl. A47F 7/00; B23P 11/00

(52) U.S. Cl. 211/59.2; 29/428

(57) ABSTRACT

A floor display having a frame and a shelf positionable on the frame. The shelf being rotateable between a first orientation in which the support pin is received within a vertically spaced aperture defined by the frame, and a second orientation in which the support pin is not received within a vertically spaced aperture of the frame.

### CROSS-REFERENCE TO RELATED APPLICATIONS

This application claims the benefit of and priority from U.S. Provisional Patent Application No. 61/347,167 filed May 21, 2010, the entire contents of which are hereby incorporated by reference.

### BACKGROUND OF THE INVENTION

The present invention relates to product displays for a retail environment.

A retail display desirably provides prominent and aesthetically pleasing display of and easy access to a product. When attempting to market a product, the seller typically wants consumers to easily recognize and remove the product from the display. Merchandise can be most easily recognized and accessed if located in a generally upright position and maintained in relatively close proximity to the forward edge of the merchandise shelf. It is also desirable for the display to be adaptable for accommodating products and packaging of varying sizes.

### SUMMARY OF THE INVENTION

Some embodiments of the present invention may provide a floor display including a frame having an upright, the upright defining a plurality of vertically spaced apertures, and a shelf having a support surface that defines a rear edge, the shelf also including a rear support spaced a distance from the rear edge to define a gap therebetween. The shelf also includes a support pin extending from the rear edge and into the gap, the support pin sized to be received within a respective one of the vertically spaced apertures.

In other embodiments, the present invention may provide a method of assembling a floor display where the floor display includes a frame having an upright defining a plurality of vertically spaced apertures, and a shelf having a support surface defining a rear edge and a rear support spaced a distance from the rear edge to define a gap therebetween. The shelf also including a support pin extending from the rear edge and into the gap. The method includes orienting the shelf into a first orientation with respect to the upright, positioning the upright in the gap while substantially maintaining the first orientation, moving the shelf vertically along the upright to a desired location, and rotating the shelf into a second orientation different from the first orientation and thereby inserting the support pin into one of the vertically spaced apertures.

In still another embodiment, the present invention may provide a floor display including a frame having an upright, a shelf having a support surface, the shelf coupleable to the upright, and a step shelf adjustably coupleable to the support surface of the shelf. The step shelf including a plurality of vertically spaced apart supplemental support surfaces, and a support member configured to interlockingly engage the support surface of the shelf in any one of multiple positions to support the supplemental support surfaces.

### BRIEF DESCRIPTION OF THE DRAWINGS

FIG. 1 is a perspective view of the floor display of the present invention.

FIG. 2 is a perspective view of the frame of the floor display of FIG. 1.

FIG. 3 is a perspective view of a shelf of the floor display of FIG. 1.

FIG. 3a is a perspective view of the shelf of FIG. 3 with the wall member removed for clarity.

FIG. 4 is a perspective view of the step shelf of the floor display of FIG. 1.

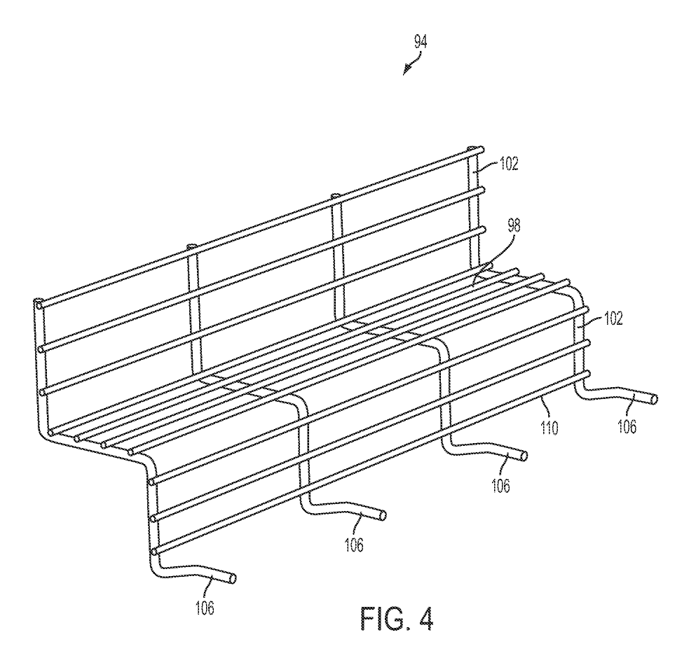

FIG. 5 is a perspective view of the floor display of FIG. 1 with the shelf in an inclined orientation.

FIG. 6 is a perspective view of the floor display of FIG. 1 with the step shelf removed from the shelf.

FIG. 7 is a section view taken along line 7-7 of FIG. 1.

### DETAILED DESCRIPTION

It is to be understood that the invention is not limited in its application to the details of construction and the arrangements of the components set forth in the following description or embodiments, or illustrated in the drawings. The invention is capable of other embodiments and of being practiced or being carried out in various ways. Also, it is to be understood that the phraseology and terminology used herein is for the purpose of description and should not be regarded as limiting.

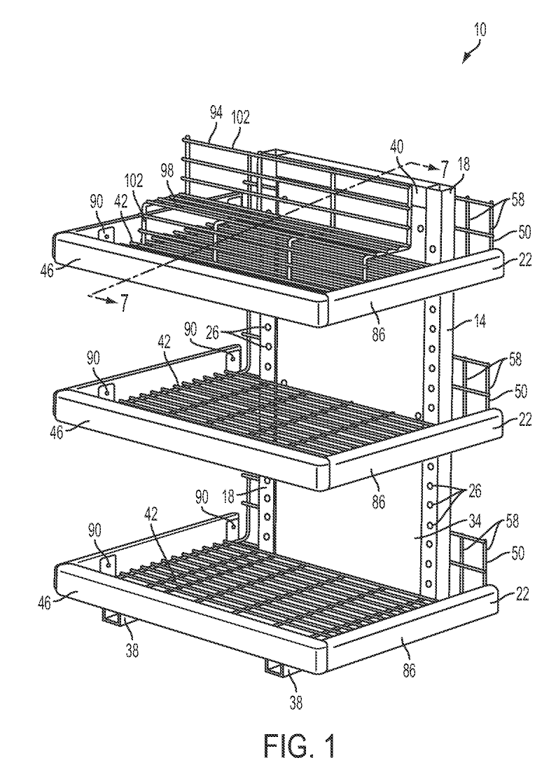

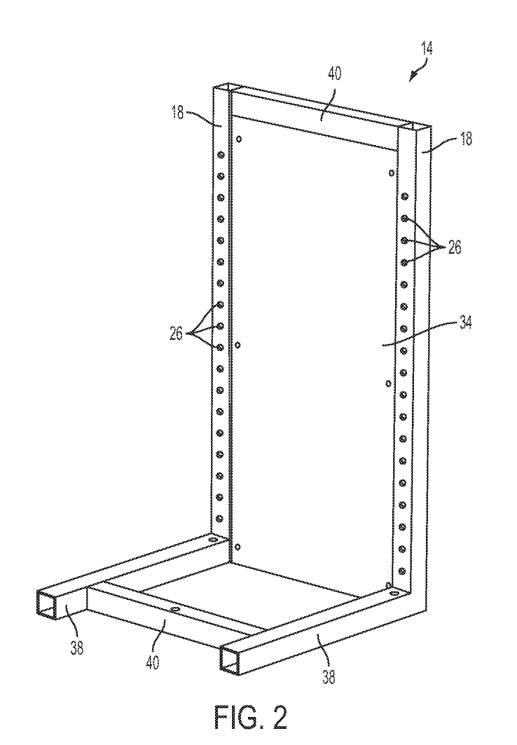

FIG. 1 illustrates a shelving unit or floor display 10 for displaying a product or plurality of products. The floor display 10 includes a frame 14 which, in the illustrated construction, includes a plurality of vertically oriented uprights 18 for supporting one or more shelves 22 (see FIG. 2). The uprights 18 are generally elongated in shape, each defining a plurality of equally spaced apertures 26 along its respective height. The apertures 26 are configured to at least partially receive a support pin 30 or other support member therein (described below). In some constructions, a plurality of protrusions or pins (not shown) may extend from the uprights 18 in place of the apertures 26. In the illustrated construction, the frame 14 is enclosed with a wall or panel 34 so the frame 14 can double as a backstop when a shelf 22 is situated on the uprights 18. In other constructions, the frame 14 may be left open. In the illustrated construction, the frame 14 also includes support legs 38 and cross-members 40 to further strengthen the shelving display 10. In alternative constructions, the frame 14 may be coupled to a base member such as, but not limited to, a wall, a floor, a workbench, and the like (not shown).

Illustrated in FIGS. 1, 3, 3a, and 5-7, each shelf 22 is couplable to and re-positionable along the height of the uprights 18. Each shelf 22 includes a support surface 42, a front wall 46 extending substantially upwardly from the support surface 42, and a rear support 50. Each shelf 22 is generally rectangular, but alternate shapes may be used dependent upon, among other things, the size and shape of the merchandise to be sold. The rear support 50 generally extends upwardly (e.g., perpendicularly) from the support surface 42 and is spaced a distance from the rear edge 54 of the support surface 42, to define a gap 60 through which the uprights 18 may extend. In alternate constructions, the angle between the rear support 50 and the support surface 42 may be altered such that the shelf 22 sits at a non-perpendicular angle relative to the uprights 18. For example, with an obtuse angle between the rear support 50 and the support surface 42, the support surface 42 would be inclined downwardly, with a forward edge of the shelf 22 positioned lower than the rear edge 54 of the shelf 22.

Each shelf 22 also includes a plurality of connecting members 58, each extending the length of the shelf 22 and having both ends turned upwardly to produce a front wall portion 62, a rear support portion 66, and a support surface portion 70. The front wall portion 62 substantially corresponds to and at least partially defines the front wall 46. The rear support portion 66 substantially corresponds to and at least partially defines the rear support 50. The support surface portion 70 extends between the front wall portion 62 and the rear support portion 66 and generally corresponds to the support surface 42. In the illustrated construction, the connecting members 58 are generally positioned adjacent the sides 74 of each shelf 22, however in alternate constructions, the connecting members 42 may be spaced along the width of each shelf 22 dependent upon the structural requirements of the display 10. For additional support, the shelf 22 may also include a plurality of secondary connecting members 78, extending substantially parallel the connecting members 58 to strengthen the support surface 42.

Each shelf 22 also includes a set of wire members 82 extending substantially perpendicular the connecting members 58 to produce the support surface 42. In the illustrated construction, the wire members 82 define a substantially planar support surface 42, however in alternate constructions, the support surface 42 may be contoured, include dividers, and the like to separate or otherwise organize and display the merchandise in a specific way. The support surface 42 may also include a biasing mechanism (not shown) to bias products towards the front of the shelf 22. In still other constructions, the wire members 82 may be replaced, or used in combination with, a piece of sheet material (e.g., metal, wood, plastic, and the like) to form the support surface 42.

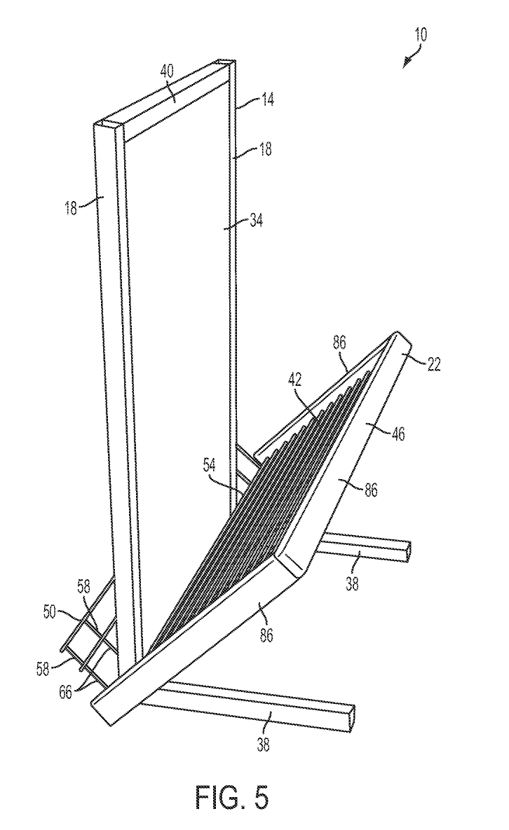

Each shelf 22 also includes at least one support pin 30 configured to be at least partially received within a corresponding aperture 26 of one of the uprights 18. Each support pin 30 extends beyond the rear edge 54 of the support surface 42 and into the gap 60, such that when the support surface 42 of the shelf 22 is oriented in a first orientation (e.g., held at an angle with respect to the upright of approximately 45 degrees, see FIG. 5), the pins 30 are removed from the apertures 26 and the shelf 22 can be freely moved along the height of the uprights 18. However, when the support surface 42 is rotated into a second orientation (e.g., positioned in a substantially horizontal orientation or approximately 90 degrees from the uprights 18, see FIG. 1), the pins 30 are received within a corresponding aperture 26 and the shelf 22 is locked into place.

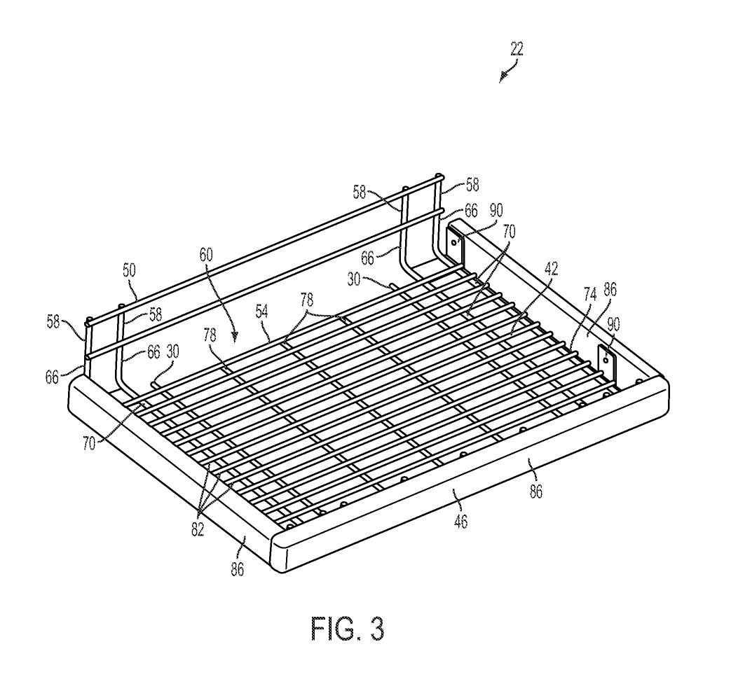

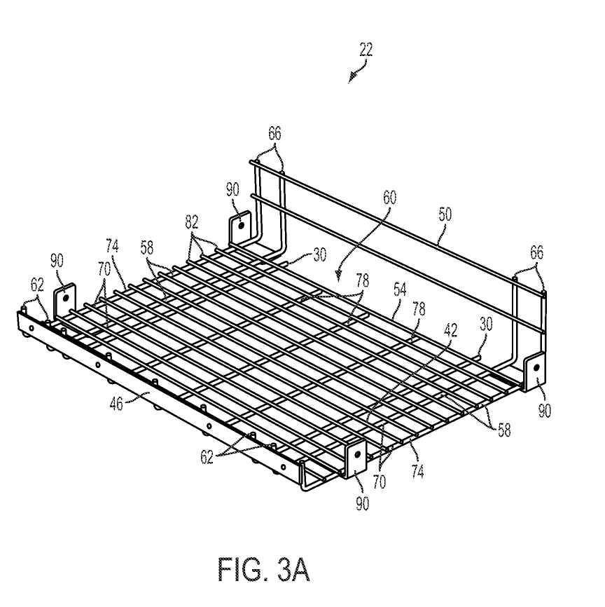

In some constructions, each shelf 22 may also include one or more wall members 86 extending along at least a portion of the periphery of the support surface 42 to help maintain the merchandise on the support surface 42 (see FIG. 3). In the illustrated construction, the wall member 86 is an elongated piece of material coupled to the shelf 22 by a plurality of tabs 90, each positioned along the periphery of the support surface 42. In some constructions, the outer wall 86 may be formed of a foam rubber or other pliable material to act as a bumper in the event someone inadvertently contacts the shelf 22. In other constructions, the wall member 86 may be formed from hard plastic, wood, metal, and the like. In still other constructions, the wall members 86 may include a plurality of metal rods extending between the upturned ends of the connecting members 58.

Although the shelves 22 of the illustrated construction are formed from a plurality of interconnected metal rods, in alternate constructions, each shelf 22 may be formed from stamped sheet material, cast, injection molded, and the like. Furthermore, each shelf 22 may include upwardly or downwardly extending supports (not shown) extending from the support surface or the wall members 86 to provide additional storage capacity. Although the illustrated construction shows three identical shelves 22, each shelf 22 of the plurality of shelves may have a unique size and/or shape dependent upon the size and shape of the merchandise to be sold.

The display 10 also includes one or more step shelves 94, each couplable to a respective shelf 22 to provide supplementary support surfaces 98 to display merchandise. Each step shelf 94 is generally formed like a flight of stairs, with each supplementary support surface 98 being staggered upwardly and rearwardly of the previous support surface. The shelves 94 also include a plurality of vertical walls 102, each extending between and supporting the supplementary support surfaces 98. The vertical walls 102 also double as a backstop for the previous support surface, with the bottommost, or first, vertical wall 102 acting as a backstop for the support surface 42. In the illustrated construction, the step shelves 94 include a single supplementary support surface 98 and a pair of vertical walls 102, however in alternate constructions, additional support surfaces 98 and vertical walls 102 may be present.

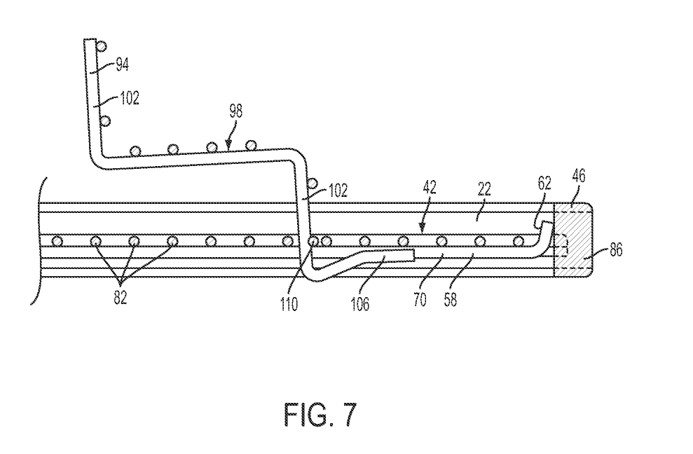

The step shelf 94 also includes a plurality of support members 106 extending from the bottom edge 110 of the first vertical wall 102 to be received under and between the connecting members 58 and wire members 82 of the shelf 22. More specifically, when the step shelf 94 is coupled to a shelf 22, the support members 106 engage a bottom portion of the wire members 82, while the bottom edge 110 of the first vertical wall 102 engages an upper portion of the connecting members 58 (see FIG. 7), this creates an interlocking construction able to support a load placed on the supplementary support surfaces 98. The interlocking nature of the step shelf 94 also allows the shelf 94 to be re-positioned within the extents of the support surface 42 of the main shelf 22 to accommodate changes in merchandise size and shape. In alternate constructions, the step shelf 94 may be coupled to the shelf 22 by any one of clamps, fasteners, pins, and the like.

Although the step shelves 94 of the illustrated construction are formed from a plurality of interconnected metal rods, in alternate constructions, each step shelf 94 may be stamped from sheet material, cast, injection molded, and the like. In alternate constructions, the step shelf 94 may also include a set of secondary support members (not shown) extending between the support surfaces 42 of the shelf 22 and one of the supplementary support surfaces 98, to provide additional load carrying capacity. In still other constructions, each step shelf 94 may be coupled to the shelves 22 in such a position that the rearward most vertical wall 102 rests against, and/or engages, the uprights 18 for additional support.

To assemble the floor display 10, a shelf 22 is oriented in the first orientation (e.g., held at an angle with respect to the frame 14). The shelf 22 is then placed over the tops of the uprights 18, whereby the uprights 18 extend through the gap 60 between the back support 50 and the rear edge 54 of the support surface 42 (see FIG. 5). As long as the shelf 22 is maintained in the first orientation, the shelf 22 is free to move along the height of the uprights 18 and into the desired location. Once positioned, the shelf 22 is rotated into the second orientation (e.g., perpendicular to the uprights 18) and the pins 30 are received within corresponding apertures 26 allowing the shelf 22 to support merchandise thereupon. The user may then add additional shelves 22 in the same manner.

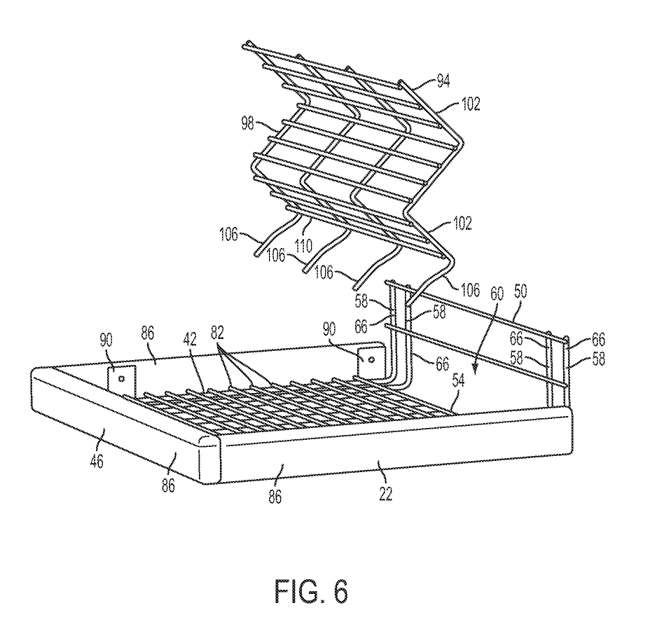

To install the step shelf 94 onto one or more shelves 22, the step shelf 94 is positioned at an angle with respect to the support surface 42 (see FIG. 6). The connecting members 106 are inserted into the mesh of wire members 82 and connecting members 58 at the desired location. The step shelf 84 may then be rotated until the connecting members 106 engage the bottom portion of the wire members 82 and the bottom edge 110 of the bottommost vertical wall 102 engages an upper portion of the connecting members 58. This causes the two shelve 22, 94 to become interlocked, allowing the step shelf 94 to support merchandise thereupon. The step shelf 94 may then be removed and repositioned (e.g., forward and back) along the support surface 42 to accommodate any changes in merchandise size or shape.

1. A floor display comprising:
a frame having an upright, the upright defining a plurality of vertically spaced apertures; and
a shelf having a support surface that defines a rear edge, the shelf also including a rear support spaced a distance from the rear edge to define a gap therebetween, and a support pin extending from the rear edge and into the gap, the support pin sized to be received within a respective one of the vertically spaced apertures.

2. The floor display of claim 1, wherein the gap is sized to receive the upright.

3. The floor display of claim 1, wherein the rear support is positioned above the support surface.

4. The floor display of claim 1, wherein the gap is sized to receive the upright, wherein when the upright extends through the gap, the shelf is rotatable between a first position in which the support pin is received within one of the vertically spaced apertures, and a second position in which the support pin is not received within any of the vertically spaced apertures.

5. The floor display of claim 4, wherein when the shelf is in the second position, the support surface forms an acute angle with the upright.

6. The floor display of claim 4, wherein when the shelf is in the first position, the support surface is substantially perpendicular to the upright.

7. The floor display of claim 4, wherein the support surface is able to support a load placed thereupon when the shelf is in the first position.

8. The floor display of claim 1, further comprising a step shelf adjustably coupled to the support surface of the shelf.

9. The floor display of claim 8, wherein the step shelf includes one or more supplementary support surfaces, each supplementary support surface spaced vertically from the support surface of the shelf.

10. The floor display of claim 4, wherein when the shelf is in the first position the support surface extends forwardly from the frame and the rear support engages a rear surface of the upright.

11. A method of assembling a floor display, the floor display including a frame having an upright defining a plurality of vertically spaced apertures, and a shelf having a support surface defining a rear edge and a rear support spaced a distance from the rear edge to define a gap therebetween, the shelf also including a support pin extending from the rear edge and into the gap, the method comprising:
orienting the shelf into a first orientation with respect to the upright;
positioning the upright in the gap while substantially maintaining the first orientation;
moving the shelf vertically along the upright to a desired location; and
rotating the shelf into a second orientation different from the first orientation and thereby inserting the support pin into one of the vertically spaced apertures.

12. The method of claim 11, wherein orienting the shelf into the first orientation includes orienting the shelf such that the support surface is at an acute angle with respect to the upright.

13. The method of claim 12, wherein orienting the shelf into the first orientation includes orienting the shelf such that the support surface is at an angle of substantially 45 degrees relative to the upright.

14. The method of claim 11, wherein rotating the shelf into the second orientation includes rotating the shelf until the support surface is substantially perpendicular to the upright.

15. The method of claim 11, further comprising:
coupling a step shelf having at least one supplemental support surface to the support surface of the shelf.

16. The method of claim 11, wherein rotating the shelf into the second orientation includes engaging the rear support with the upright.

17. A floor display comprising:
a frame having an upright;
a shelf having a support surface, the shelf couplable to the upright; and
a step shelf adjustably couplable to the support surface of the shelf, the step shelf including:
a plurality of vertically spaced apart supplemental support surfaces, and
a support member configured to interlockingly engage the support surface of the shelf in any one of multiple positions to support the supplemental support surfaces.

18. The floor display of claim 17, wherein each supplemental support surface is spaced above and rearward of a preceding supplemental support surface.

19. The floor display of claim 17, further comprising a plurality of vertical walls extending between the supplemental support surfaces.

20. The floor display of claim 17, wherein the support surface of the shelf includes a plurality of wire members, and wherein when the step shelf is installed on a shelf the support member is positioned below and between the wire members.
